(19) United States
(12) Patent Application Publication
(10) Pub. No.: US 2002/0184965 A1
(43) Pub. Date: Dec. 12, 2002

(54) Automatic balancing apparatus

(76) Inventor: Atsushi Honda, Nagano (JP)

Correspondence Address: REED SMITH, LLP, ATTN: PATENT RECORDS DEPARTMENT, 599 LEXINGTON AVENUE, 29TH FLOOR, NEW YORK, NY, 10022-7650, US

(21) Appl. No.: 10/160,536

(22) Filed: May 31, 2002

(30) Foreign Application Priority Data
May 31, 2001 (JP) 2001-164392

(51) Int. Cl. F16F 15/22

(52) U.S. Cl. 74/573 R

(57) ABSTRACT

The present invention discloses an automatic balancing apparatus including moveable balancing members located in hollow tubular portions of a rotating member which may include a rotation shaft and a turntable. The automatic balancing apparatus suppresses vibration of the rotation shaft and turntable by adjusting a center of gravity with balancing members so that even high speed rotation of the shaft is possible without excessive vibration. The present invention uses magnets and may use low friction surfaces to further improve the free and fine movement of the balancing members which ensures a finely tuned balancing apparatus in operation.

This application claims foreign priority to Japanese patent application 2001-164392 filed May 31, 2001.

### FIELD OF INVENTION

The present invention relates to a motor that is used to drive driving rotation of data storage media disks such as flexible disks, CDs, and DVDs. More specifically, it relates to a mechanism for automatic suppression of vibration including vibration in the horizontal (tracking) direction of a data storage disk rotated by a motor and the like.

### BACKGROUND OF INVENTION

Usually, the rotation speed requirement for a recording and reproducing apparatus, which rotates a data storage disk, is 6,000-10,000 rpm. However, a disk loses its balance during rotation due to its uneven thickness or a printing media labeled on the disk providing an uneven mass during rotation. When rotating such a disk at a high speed, a centrifugal force acts on a biased rotation center of the disk. Particularly, at a certain speed called a “dangerous speed,” at which the speed of the rotation shaft reaches a specific horizontal frequency of the rotation system, the rotation shaft vibrates very hard in the horizontal direction (in the direction orthogonal to the shaft direction). For this reason, high-speed rotation of a disk causes inconveniences such as generation of noise, reduction of a disk's usable life time due to vibration-induced damages, or failing of recording or reproduction on a disk due to a tracking error and the like. In addition, such vibrations may propagate to adversely affect peripheral terminals.

### SUMMARY OF THE INVENTION

For this reason, unfavorable vibrations due to unbalanced rotation of a disk must be suppressed. In FIG. 4, spindle motor 51 comprises: stator 53 fixed onto hub 52; rotor 54 having magnet 54a arranged opposite to stator 53; and spindle shaft 55 rotatably supported by bearing 52a. When current flows through stator 53, a magnetic field for rotating rotor 54 is generated between stator 53 and rotor 54 and rotor 54 rotates around spindle shaft 55 integrally.

Automatic balancing apparatus 56 is constructed with case 57 that is fixed onto spindle shaft 55 and a turntable (not illustrated) such that all of these components rotate together. In case 57, a tubular space is formed circumferentially around spindle shaft 55 and a ring-like magnet 58 is arranged along the inner circumference of the tubular space. Ring-like magnet 58 is magnetized such that a magnetic flux is generated in a direction other than the circumference of spindle shaft 55. In addition, a selected number of multiple (magnetic) balls 59 made of a magnetic material having the same diameter are inserted along circumference of magnet 58 in the space provided in case 57 to suppress horizontal vibration. Therefore, when spindle shaft 55 does not rotate, balls 59 are held to the circumferential surface of magnet 58 by magnetic force.

Automatic balancing apparatus 56 as configured in the above mentioned manner rotates together with spindle shaft 55 while balls 59 are attached to the circumferential surface of magnet 58 as spindle motor 51 is actuated. As the rotation of spindle shaft 55 accelerates and rotation speed exceeds a specific horizontal frequency, the magnitude of centrifugal force exceeds the attracting force of magnet 58. As a result, balls 59 are removed from magnet 58 and moved (pushed) toward the case's outer circumferential wall 57a. Such movement of balls 59 approximates a new center of gravity at the center of rotation shaft, thereby suppressing vibration due to the spindle shaft rotating at a high speed.

Nevertheless, balls 59 move contacting two points, the case's outer circumference wall 57a and the case's bottom surface 57b under the influence of centrifugal force and gravity. For this reason, the movement of balls 59 is diminished due to friction generated between the circumference wall 57a and the bottom surface 57b of the case (tubular space), preventing balls 59 from reaching the perfect balancing point (equilibrium) and from canceling the amount of vibration generated during high-speed spinning.

The object of the present invention is to provide an automatic balancing apparatus with a rotation member with improved balancing capability that generates little vibration during rotation by decreasing the contact pressure to reduce friction generated between the case's circumference wall and the case's bottom surface.

To accomplish the task, the automatic balancing apparatus of the present invention is constituted as follows: an automatic balancing apparatus having a hollow tubular portion containing balancing members is fixed onto a rotation shaft wherein, when a frequency of rotation members that are integrally rotated by a driving source exceeds a resonance frequency of a system comprising the rotation shaft and the rotation member, the automatic balancing apparatus suppresses vibration derived from the rotation member being unbalanced, and at least one of the inner walls in the hollow tubular portion includes a single polarity magnet. The hollow tubular portion may be molded using a synthetic resin mold and the magnet may be integrally formed or press fitted using the insert-mold. Also, the magnet or tubular space may have a surface (exposed in the tubular space) coated with a synthetic resin film.

The balancing member contains a plurality of balls having the same diameter (to suppress horizontal vibrations). Also, the hollow tubular portion partitions a tubular space by assembling an upper tubular portion and a lower tubular portion, wherein the upper tubular portion provides a space opening downward between an inner wall near the rotation member's rotation center and an outer wall surrounding the inner wall; the lower tubular portion provides a tubular space opening upward by connecting an inner support plate to be engaged with a tubular mating wall provided inside the inner wall, and outer support plate to be engaged with the outer wall on a tubular bottom plate; and a plurality of the balls are inserted into the tubular portion such that multiple balls can move freely therein.

In the hollow tubular portion, a cylindrical magnet is attached along the inner wall and a crossectionally L-shaped magnet is integrally formed with a turntable using an insert mold, wherein the crossectionally L-shaped flat ring-like magnet has a magnetized plane of a polarity which is different form the cylindrical magnet and extends radially from top of the cylindrical magnet toward the outside. A flat ring-like magnet may only extend radially from top of the cylindrical magnet toward the outside. Also, the hollow tubular portion comprises: a flat ring-like magnet extending radially from the upper end of the inner wall near its rotation center toward the outside; a back yoke made of a magnetic plate may be provided such that the back yoke is sealingly attached to the flat ring-like magnet between the hollow tubular portion's base; a cylindrical yoke may extend vertically from the inner end of the back yoke downward so as to surround the hollow tubular portion's inner wall.

### BRIEF DESCRIPTION OF THE DRAWINGS

FIG. 1 is a schematic side view showing a cross section of the automatic balancing apparatus of Embodiment 1 of the present invention.

FIG. 2 is a schematic side view showing a magnified cross section of a part of the automatic balancing apparatus of Embodiment 2 of the present invention.

FIG. 3 is a schematic side view showing a magnified cross section of a part of the automatic balancing apparatus of Embodiment 3 of the present invention.

FIG. 4 is a schematic side view showing a cross section of an automatic balancing apparatus of conventional technology together with a spindle motor.

### DETAILED DESCRIPTION OF THE INVENTION

Embodiments of the automatic balancing apparatus of the present invention are described herein with reference to the drawings. FIG. 1 is a schematic configuration showing a cross section of Example I of the automatic balancing apparatus of the present invention. In FIG. I, Reference Number 10 is the automatic balancing apparatus. Spindle motor 11 of the present invention is a driving source that rotates disk-type data storage media (not illustrated) such as CDs, DVDs, and magneto-optical disks. In spindle 11, rotor 13 constituting rotation member R rotates when current flows to stator 12.

Stator 12 comprises stator hub 14 fixed onto a mechanical chassis (not illustrated) and stator member 15 fixed onto stator hub 14. Stator hub 14 comprises bearing case 17 supporting rotation shaft 16, which is the rotation center of rotor 13. Bearing 18 is attached to bearing case 17 to rotatably support rotation shaft 16 formed integral with rotor 13, is attached to bearing case 17. In rotor 13, cylindrical yoke 20 is provided in such a way that rotor magnet 19 is secured inside cylindrical yoke 20 and rotor 19 and stator member 15 are arranged opposite to each other.

Turntable 21 is press fitted to rotation shaft 16 through center hole 21a to be concentric with rotor 13. Boss 21b to be mated with the clamp hole of a data storage medium such as CD and magneto-optical disk (not illustrated) is formed integral with turntable 21 such that a disk is centered as its clamp hole and boss 21b are mated with each other. Facing yoke 22 is embedded on top of boss 21b and a disk is securely wedged between turntable surface 21c and a magnet embedded to a clamper (not illustrated). The damper has a projection in its center which press fits into the same center hole 21a as turntable 21, to which rotation shaft 16 is press fitted. As a result, the clamper is automatically aligned with rotation shaft 16 in a concentric manner. Thin plate 23 made of a rubber band is attached along the circumference of turntable surface 21c so as to efficiently retain the disk by means of friction and to protect the disk surface from scratches.

Turntable 21 is molded utilizing a synthetic resin mold. Automatic balancing apparatus 10 is molded integrally with the circumference of turntable 21. In other words, automatic balancing apparatus 10 is fixed onto rotation shaft 16 with a damper and a disk via turntable 21 in an integral manner, thereby constituting part of rotation member R. Automatic balancing apparatus 10 is constructed with a hollow tubular portion 25 containing multiple magnetic balls 24 configured to be concentric to turntable 21. That is, upper tubular portion 25-1 comprises partitions created by: (1) inner wall 25a along the circumference of turntable 21, which is part of rotation member R near the center of rotation; (2) outer wall 25b of the same height as inner wall 25a extending downward; and (3) upper surface 25d, which is the tubular portion constituting a part of the circumference of turntable 21 with opening 25c therebelow.

On turntable 21, tubular mating wall 25e to be engaged with lower tubular portion 25-2 described later is given nearly the same height as the inner wall 25a and extends from inner wall 25a toward the rotation center of turntable 21 so as to be engaged with cylindrical inner support plate 25-2c, which extends upward from inner edge 25-2b of tubular bottom plate 25-2a in lower tubular portion 25-2. In addition, cylindrical outer support plate 25-2e extends upward from outer circumference 25-2d of tubular bottom plate 25-2a in lower tubular portion 25-2 to be engaged with outer wall 25b extending downward from turntable 21. Upper end 25-2f is of outer support plate 25-2e is given enhanced resistance to centrifugal force induced deformation such that the outer neck (corner) from which outer wall 25b hangs downward from turntable 21 is fitted into a narrow groove 21e formed in the thickness (vertical) direction of turntable 21 on outer support plate 25-2e.

Lower tubular portion 25-2, into which an appropriate number of independent magnetic balls 24 having the same diameter are inserted such that the balls 24 can move freely, is press fitted to upper tubular portion 25-1. Tubular bottom plate 25-2a of lower tubular portion 25-2 closes opening 25c below upper tubular portion 25-1 to partition tubular space 25d in hollow tubular portion 25. Lower tubular portion 25-2 is formed by molding a synthetic resin such that magnetic balls 24 generate little noise when they contact each other and move.

Cylindrical magnet 26, having a free surface magnetized in a single polarity, is sealingly attached along the outer circumference of inner wall 25a in upper tubular portion 25-1 to be fixed thereon and a flat ring-like magnet 27 is sealingly attached onto upper surface 21d in upper tubular portion 25-1 to be fixed thereon. Flat ring-like magnet 27 is magnetized with a polarity different from that of the free surface of cylindrical magnet 26 and molded integral with cylindrical magnet 26 so as to form a cross-sectional L-shape. For this reason, when turntable 21 does not rotate, magnetic balls 24 housed in tubular space 25d are attracted (to two points) in the direction of corner 28, cylindrical magnet 26 on inner wall 25a and flat ring-like magnet 27 on upper surface 21d, thereby staying still in equilibrium (See the left hand side of FIG. 1).

Turntable 21 is molded utilizing a synthetic resin. Cylindrical magnet 26 and flat ring-like magnet 27 are formed integrally using an insert-mold, providing a composite magnet shaped in an inverse L in cross-section. Each cylindrical magnet 26 and flat ring-like magnet 27 is magnetized in a single polarity wherein the polarity may be either the same or different. A back yoke (not illustrated) may be insert-molded between inner wall 25a and cylindrical magnet 26, and between upper surface 21d and flat ring-like magnet 27. Moreover, if a synthetic resin coating is provided on the surfaces of cylindrical magnet 26 and flat ring-like magnet 27 exposed to tubular space 25d in hollow tubular portion 25, noise from bombardment of magnetic balls 24 can be suppressed.

Operation of the automatic balancing apparatus 10 of the present invention is described herein. As turntable 21 having an unbalanced data storage disk begins rotating, a centrifugal force exercises its automatic center adjusting effect such that magnetic balls 24 themselves move to a balancing point and the resulting center of gravity stays on the rotation shaft 16. An unbalanced data storage disk, therefore, can be spun at a high speed while maintaining its balancing point on the rotation shaft 16. Such an automatic center adjusting effect is desirable when the frequency of the combined rotation member R exceeds the number of specific horizontal frequency (resonance frequency) of combined rotation member R itself. In the left side of FIG. 1, turntable 21 is in a static state. FIG. 1 also depicts the position of magnetic balls 24 when they are spun at a slow speed. The right side of FIG. 1 depicts the position of magnetic balls 24 when they are spun at a high speed.

The automatic balancing point adjustment effect works in the above mentioned rotation system as follows: when the centrifugal force of the rotational system exceeds the attracting force from cylindrical magnet 26 on inner wall 25a, magnetic balls 24 are removed from cylindrical magnet 26 and are moved (pushed) to the inner surface of outer wall 25b. However, being repelled, or attracted depending upon the embodiment, by cylindrical magnet 26 to inner wall 25a, magnetic balls 24 contact the inner surface of outer wall 25b only with a small pressure, limiting the friction generated thereon to prevent magnetic balls 24 from moving toward the balancing point along the inner surface of outer wall 25b.

Magnetic balls 24 also slide along bottom surface 25-2g of tubular bottom plate 25-2a in lower tubular portion 25-2 due to gravity. The magnetic force from flat ring-like magnet 27 attached to the upper surface 21d of upper tubular portion pushes magnetic balls 24 against bottom surface 25-2g, or pulls away from the bottom surface 25-2g depending upon the polarity of the magnet selected to be used, mitigating the contacting pressure thereon. The unfavorable friction that works against magnetic balls 24 from moving toward the balanced point is thus eliminated. Moreover, by molding lower tubular portion 25-2 utilizing a synthetic resin having a low friction coefficient, magnetic balls 24 can move more smoothly. As described, automatic balancing apparatus 10 of the present invention allows magnetic balls 24 to reach the balancing point quickly and smoothly, thereby improving balancing effectively.

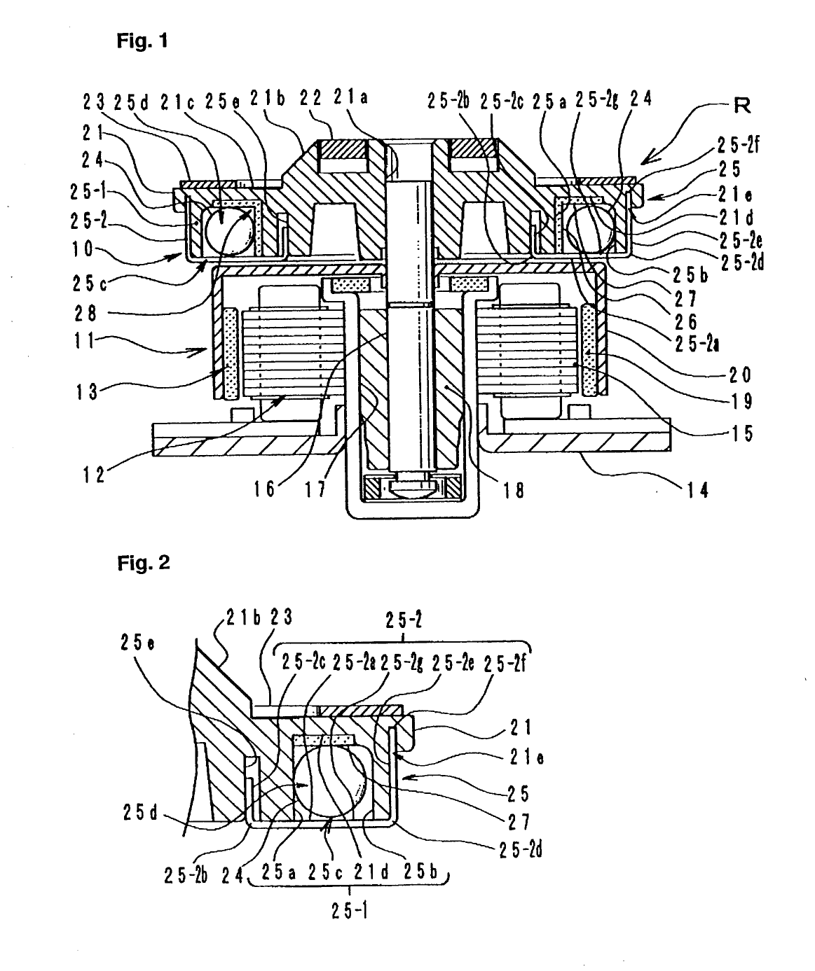

FIG. 2 shows the automatic balancing apparatus of Embodiment 2 of the present invention depicting a magnified side view of a part of hollow tubular portion 25 in cross section. Members that are common to Embodiment 1 are given the same reference symbols and their descriptions are not repeated. Embodiment 2 differs from Embodiment 1 in that the flat ring-like magnet 27 is attached to upper surface 21d of hollow tubular portion 25 and the cylindrical magnet on the inner wall 25a is eliminated. By eliminating cylindrical magnet on inner wall 25a, the cost of the component is saved. When a small centrifugal force is applied to the rotation system, the magnetic force from flat ring-like magnet 27 alone can reduce the contact pressure on both the inner surface of outer wall 25b and bottom surface 25-2g.

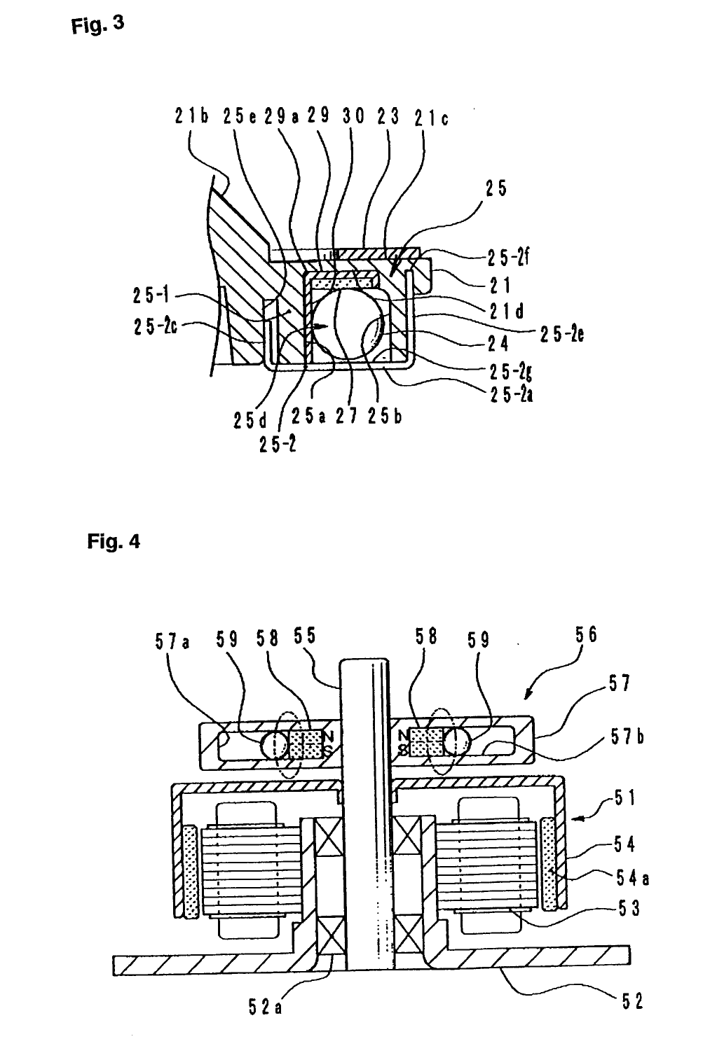

FIG. 3 shows the automatic balancing apparatus of Embodiment 3 of the present invention depicting a magnified side view of a cross section of hollow tubular portion 25. Members that are common to the embodiments previously discussed are given the same reference symbols and their descriptions are not repeated. In Embodiment 3, a ring-like back yoke 29 made of a magnetic plate is pinched between upper surface 21d of upper tubular portion 25-1 and flat ring-like magnet 27 utilizing the insert mold technique. Cylindrical yoke 30 hangs vertically against the points between inner edge 29a of ring-like back yoke 29 and inner wall 25a. Embodiment 3 is applicable to a relatively well-balanced rotation system not affected by centrifugal force and the differential magnetic force required for flat ring-like magnet 27 (to maintain equilibrium) is supplemented. It is particularly desirable to stop magnetic balls 24 in a stable manner when turntable 21 does not rotate.

Embodiments of the automatic balancing apparatus of the present invention as applied to a turntable that holds a data storage disk have been described above. However, these embodiments do not limit the present invention. The spirit of the present invention is to provide a smooth movement for balls by taking advantage of the automatic center adjustment effect. The automatic balancing apparatus of the present invention may be applied to a rotor or a clamper, or even another independent member may be provided as long as the rotation system rotates integral with a turntable. The present invention may be applied to any applications with many different modifications as long as the operation of a rotation member that rotates at a high speed exceeds the resonance frequency and is within the scope of claims. A good result should be expected in any case.

As is apparent from what is described above, the automatic balancing apparatus of the present invention limits the magnitude of influence from centrifugal force exercised on magnetic balls contained in a hollow tubular portion utilizing the magnet's attracting force, thereby reducing the friction from contact between magnetic balls and the inner surface of the outer wall in the hollow tubular portion. It also limits the influence of gravity exercised on the magnetic balls contained in the hollow tubular portion utilizing the attracting force from a magnet attached to the upper surface side in the hollow tubular portion, thereby reducing the friction between magnetic balls and the bottom surface of the hollow tubular portion. Magnetic balls thus have an easy-to-move feature. They move to the balancing point smoothly and quickly to establish equilibrium, thereby ensuring reduction of vibration.

If an exposed surface of a magnet is coated with a synthetic resin film, noise generated by the magnetic balls' contacting the walls can be reduced. Moreover, two surfaces of the hollow tubular portion are given a single polarity, therefore, multiple magnetic balls can be magnetized to the same level. Magnetic balls are unlikely to push against each other, reducing noise and vibration generated by the balls contacting each other.

As described above, by limiting the rate of vibration acceleration, little side pressure generated by loss of equilibrium is applied to the spindle motor bearing. As a result, problems such as an increase in torque due to damages to the shaft, damages to bearings (magnetic balls) and a reduction in useable life of bearings (magnetic balls) are resolved. CDs, DVDs, magneto-optical disks can thus record and reproduce data in a stable fashion.

What is claimed is:

1. An automatic balancing apparatus comprising:
a rotation shaft;
a turntable connected to the rotation shaft;
hollow tubular portions located in the turntable; and
moveable balancing members located in the hollow tubular portions for suppressing vibration of the rotation shaft and turntable by adjusting a center of gravity;
wherein at least one of a plurality of inner walls of the hollow tubular portions uses at least one magnet structurally oriented to use only a single polarity for magnetically affecting the moveable balancing members to improve movement of the moveable balancing members by mitigating forces impeding the free movement of the moveable balancing members.

2. The automatic balancing apparatus of claim 1 wherein the has a surface coated with a synthetic resin film for the moveable balancing members to move in proximity to.

3. The automatic balancing apparatus of claim 1 wherein the balancing members comprise a plurality of balls.

4. The automatic balancing apparatus of claim 1 wherein said hollow tubular portions further comprise:
partitions of a tubular space by assembling an upper tubular portion and a lower tubular portion,
and a plurality of magnetic balls inserted into the hollow tubular portions wherein the upper tubular portion provides a space opening downward between an inner wall near the turntable's center and an outer wall surrounding the inner wall;
the lower tubular portion providing a tubular space opening upward with an inner support plate connected thereto wherein the inner support plate is engaged with a tubular mating wall provided inside the inner wall and an outer support plate engaged with said outer wall on a tubular bottom plate.

5. The automatic balancing apparatus of claim 1 wherein:
a cylindrical magnet in attached along the inner wall;
and a cross-sectionally L-shaped magnet is integrally formed with the turntable in the hollow tubular portion using an insert in the hollow tubular portion wherein the cross-sectionally L-shaped flat ring-like magnet has a plane magnetized in a polarity different from the cylindrical magnet and extends radially from top of the cylindrical magnet toward the outside.

6. The automatic balancing apparatus of claim 1 wherein a flat ring-like magnet extends radially from top of said inner wall near its rotation center toward the outside.

7. The automatic balancing apparatus of claim 1 wherein the hollow tubular portion comprises:
a flat ring-like magnet extending radially from top of the inner wall near its rotation center toward the outside;
a back yoke made of a magnetic plate which is sealingly attached to the flat ring-like magnet being placed between an upper surface of the hollow tubular portion's base and the flat ring-like magnet;
and a cylindrical yoke, extending vertically from an inner end of said back yoke downward around said hollow tubular portion's inner wall.

8. The automatic balancing apparatus of claim 1 wherein the tubular portions have surfaces coated with a synthetic resin film for the moveable balancing members to move in proximity to.

9. The automatic balancing apparatus of claim 1 wherein the suppressed vibration of the rotation shaft and turntable is substantially orientated in a direction orthogonal to the axis of the rotation shaft.

10. An automatic balancing apparatus comprising:
a hollow tubular portion containing balancing members and fixed onto a rotation shaft structured wherein when a frequency of rotation members that are integrally rotated by a driving source exceeds a horizontal resonance frequency of a system comprising said rotation shaft and said rotation members, said automatic balancing apparatus suppresses vibration derived from said rotation member being unbalanced, and
at least one inner walls of said hollow tubular portion includes a single pole magnet.

11. An automatic balancing apparatus as set forth in claim 10 wherein said magnet has an exposed surface coated with a synthetic resin film.

12. An automatic balancing apparatus as set forth in claim 10 wherein said balancing member contains a plurality of balls of the same diameter for effectively suppressing horizontal vibration.

13. An automatic balancing apparatus as set forth in claim 10 wherein said hollow tubular portion is partitioned into a tubular space comprising:
an upper tubular portion and a lower tubular portion,
a plurality of magnetic balls inserted into said hollow tubular portion, wherein said upper tubular portion provides a space opening downward between an inner wall near said rotation member's center and an outer wall surrounding said inner wall; and
said lower tubular portion providing a tubular space opening upward with an inner support plate connected thereto, wherein said inner support plate is engaged with a tubular mating wall provided inside said inner wall and an outer support plate is engaged with said outer wall on a tubular bottom plate.

14. An automatic balancing apparatus as set forth in claim 10 wherein
(1) a cylindrical magnet in attached along said inner wall and;
(2) a cross-sectionally L-shaped magnet are integrally formed with a turntable in said hollow tubular portion using an insert mold in said hollow tubular portion, wherein said cross-sectionally L-shaped flat ring-like magnet has a plane magnetized in a polarity different from said cylindrical magnet and extends radially from top of said cylindrical magnet toward the outside.

15. An automatic balancing apparatus as set fort in claim 10 wherein a flat ring-like magnet extends radially from top of said inner wall near its rotation center toward the outside.

16. An automatic balancing apparatus as set forth in claim 10 wherein said hollow tubular portion further comprises:
a flat ring-like magnet extending radially from top of said inner wall near its rotation center toward the outside;
a back yoke made of a magnetic plate, which is sealingly attached to said flat ring-like magnet being placed between an upper surface of said hollow tubular portion's base and said flat ring-like magnet;
and a cylindrical yoke, extending vertically from an inner end of said back yoke downward around said hollow tubular portion's inner wall.
